(19) United States
(12) Patent Application Publication
(10) Pub. No.: US 2025/0257182 A1
(43) Pub. Date: Aug. 14, 2025

(54) RECYLCLABLE LAMINATE STRUCTURES COMPRISING POLYOLEFIN DISPERSIONS AS LAMINATING ADHESIVES

(71) Applicants: Dow Global Technologies LLC, Midland, MI (US); Rohm and Haas Company, Collegeville, PA (US)

(72) Inventors: Hari Katepalli, Midland, MI (US); David L. Malotky, Midland, MI (US); Daniele Vinci, Luzem (CH); Franca Arrighi, Mozzate (IT)

(21) Appl. No.: 18/856,749

(22) PCT Filed: May 9, 2023
(86) PCT No.: PCT/US2023/021473

§ 371 Date: Oct. 14, 2024

(30) Foreign Application Priority Data
May 9, 2022 (IT) 102022000009434

(51) Int. Cl. C08J 7/04; B65D 65/42

(52) U.S. Cl. CPC C08J 7/0427; B65D 65/42; C08J 2323/08; C08J 2423/08

(57) ABSTRACT

A recyclable laminate structure comprising at least one polyolefin substrate layer and a recyclable polyolefin dispersion comprising a polyolefin based polymer, a polar component present as a salt, and a neutralizing agent along with a process for producing the laminate structure is disclosed. The recyclable laminate structure is applicable via a known application process and has improved recyclability properties.

### FIELD

The current disclosure relates to mechanically recyclable laminate structures comprising polyolefin dispersions, and more specifically to recyclable laminate structures including at least one polyolefin substrate layer having a polyolefin dispersion disposed thereon and used as an adhesive layer, the polyolefin dispersion being applied via known application systems to a surface of the polyolefin substrate. The disclosed polyolefin dispersions and resulting recyclable laminate structures may be used in manufactured articles such as flexible packaging and have beneficial recyclability properties.

### BACKGROUND

Polyurethane based adhesives are widely used in the packaging industry for flexible packages, including flexible food packagings. Solvent based polyurethane adhesives are applied via gravure or flexographic application systems while solvent free systems are applied using five roller application systems. If the flexible package is to be used for a food product, bond strength and sealing condition resistance are imperative.

Traditional flexible package design is based on lamination of functional layers such as polyethylene terephthalate (PET), bi-axially oriented polypropylene (BOPP), metalized PET oriented polypropylene (OPP), aluminum foils, and nylon/polyimide with a sealable layer such as low density polyethylene (LDPE), or cast polypropylene (CPP). Since there is no economically practical and technically efficient process of layer separation and individual film recycling, traditional flexible packages are non-recyclable. Traditionally used laminating adhesives have included either acrylic-based or polyurethane-based adhesives. Combinations of different polyolefin films laminated with such traditional adhesives are challenging to recycle due to chemical differences between the laminating adhesive and the film's polyolefin backbone, along with the highly crosslinked nature of the adhesive.

Thus, a need exists for an adhesive that enables fully recyclable laminate structures with all the beneficial properties described above, namely good performance and enablement of recyclable packaging.

### DETAILED DESCRIPTION

Presently disclosed are fully polyolefin recyclable laminate structures comprising at least one recyclable polyolefin substrate layer and a polyolefin dispersion, applicable via known application systems, disposed on at least a portion of the surface of the at least one recyclable polyolefin substrate layer. A mechanically recyclable multi-layer laminate comprising at least two recyclable polyolefin layers laminated together using a polyolefin dispersion, applicable via a known application system, is also presently disclosed.

### Polyolefin Substrate Layer:

The disclosed polyolefin substrate layers are made from an olefin-based polymer. The term “olefin-based polymer,” “olefinic polymer,” and “polyolefin” as used herein refer to a polymer that comprises a majority of olefin monomer. The term “polymer” refers to a polymeric compound prepared by polymerizing monomers, whether of the same or different types. The generic term polymer thus embraces the term “homopolymer” usually employed to refer to polymers prepared from only one type of monomer as well as “copolymer” which refers to polymers prepared from two or more different monomers. The polyolefin substrate layer may comprise a film made from one polyolefin polymer or a film made from a blend of two or more different polyolefin polymers.

The polyolefin substrate layer may comprise an ethylene-based polymer. As described herein “polyethylene” or an “ethylene-based polymer” shall mean polymers comprising greater than 50% by mole of units derived from ethylene monomer. This includes ethylene-based homopolymers or copolymers as aforementioned. Common forms of polyethylene known in the art include, but are not limited to low density polyethylene (LDPE); linear low density polyethylene (LLDPE) ultra low density polyethylene (ULDPE); very low density polyethylene (VLDPE); single-site catalyzed linear low density including both linear and substantially linear low density resins (m-LLDPE); medium density polyethylene (MDPE); and high density polyethylene (HDPE). For example, the polyolefin substrate layer, can include one or more polyolefin layers such as HDPE, LDPE, LLDPE, MDO PE, BOPE, and mixtures thereof.

Additionally, as described herein, the term “LDPE” may also be referred to a “high pressure ethylene polymer” or “highly branched polyethylene” and is defined to mean that the polymer is partly or entirely homopolymerized or copolymerized in an autoclave or a tubular reactor at pressures above 14,500 psi (100 MPa) with the use of free-radical initiators, such as peroxides (see, e.g., U.S. Pat. No. 4,599,392). LDPE resins typically have a density in the range of 0.916 g/cm to 0.940 g/cm.

The term “LLDPE”, as described herein, may include resins made using Ziegler Natta catalyst systems as well as resins made using single-site catalysts, including, but not limited to, bis-metallocene catalysts (sometimes referred to as “m-LLDPE”), phosphinimine, and constrained geometry catalysts; and resin made using post-metallocene, molecular catalysts, including, but not limited to, bis(biphenylphenoxy) catalysts (also referred to as polyvalent aryloxyether catalysts). LLDPE includes linear, substantially linear, or heterogeneous ethylene-based copolymers or homopolymers. LLDPEs contain less long chain branching than LDPEs and include the substantially linear ethylene polymers, which are further defined in U.S. Pat. Nos. 5,272,236, 5,278,272, 5,582,923, and 5,733,155; the homogeneously branched ethylene polymers such as those described in U.S. Pat. No. 3,645,992; the heterogeneously branched ethylene polymers such as those prepared according to the process disclosed in U.S. Pat. No. 4,076,698; and blends thereof (such as those disclosed in U.S. Pat. No. 3,914,342 or U.S. Pat. No. 5,854,045). The LLDPE resins can be made via gas-phase, solution-phase, or slurry polymerization as well as any combination thereof using any type of reactor or reactor configuration known in the art. The LLDPE resins can be made via gas-phase, solution-phase, or slurry polymerization as well as any combination thereof, using any type of reactor or reactor configuration known in the art.

Additionally, as described herein, the term “HDPE” refers to polyethylenes having densities of about 0.940 g/cm or greater, which are generally prepared with Ziegler-Natta catalysts, chrome catalysts or even metallocene catalysts. The polyolefin substrate layer can be a multilayer film which includes an outer layer comprising an ethylene-based polymer.

The polyethylene polymer suitable for use in the present disclosure may be commercially available. Suitable commercial polyethylene polymers include but are not limited to: AGILITY™ (e.g., AGILITY™ 1000, AGILITY™ 1001, and AGILITY™ 1021), INNATE™ ST 50, ELITE™ 5940, ELITE™ 5960, DOW™ LDPE 6211, and DOW™ LDPE 7511, all of which are available from The Dow Chemical Company.

The polyolefin substrate layer used for making the recyclable laminate structures of the present disclosure can include a single layer (monolayer) made of one or more polyolefins, olefinic polymers, or ethylene vinyl acetate (EVA); or the recyclable laminate structures can include a multilayer structure made of one or more polyolefin layers.

The polyolefin substrate layer of the present disclosure may be a multilayer film which contains more than one layer. As described herein, a “multilayer film” means any film having more than one layer. For example, the multilayer film may have two, three, four, five, or more layers. A multilayer film may be described as having the layers designated with letters to assist in describing the film. For example, a two-layer film having two different polyolefin film layers can be designated as A/B; and a three-layer film having a core layer B, and two external layers A and C may be designated as A/B/C. Likewise, a structure having two core layers B and C and two external layers A and D would be designated A/B/C/D. The polyolefin films may be coextruded films with an odd number of layers from 3 to 35, such as from 3 to 11 or from 3 to 7. For example, the polyolefin substrate layer may be a three-layer multilayer film comprised of three layers of polyethylene.

The polyolefin substrate layer can be a multilayer film comprised of one or more layers of HDPE, LLDPE, and LDPE; a PP film a biaxially oriented PP (BOPP) film layer, or a machine-direction oriented PE (MDO PE) or a biaxially oriented PE (BOPE).

The thickness of the polyolefin substrate layer can be, for example, from 12 (μm) to 125 μm, from 20 μm to 100 μm, or from 25 μm to 50 μm.

The polyolefin substrate layer may have a thickness of less than or equal to (≤) 1 mm, such as ≤900 μm, ≤800 μm, ≤700 μm, ≤600 μm, ≤500 μm, ≤400 μm, ≤300 μm, or even≤200 μm. The polyolefin substrate layer may have a thickness of greater than or equal to (≥) 1 μm, ≥5 μm, ≥10 μm, ≥20 μm, ≥30 μm, ≥40 μm, or even≥50 μm. As is understood by those skilled in the art, in multilayer films, the thicknesses of the different layers can be the same or different; and layer thicknesses may be selected by techniques known to those having skill based on the disclosure herein.

The polyolefin substrate layers can be produced with low density polymers. The polyolefin substrate layer can be polyethylene/polyethylene films or polypropylene/polypropylene films. The polyolefin substrate layer can be blown or co-extruded.

### Polyolefin Dispersion:

The recyclable laminate structures disclosed herein can comprise a water-based polyolefin dispersion. The polyolefin dispersion can comprise a polyolefin-based polymer, a polar component present as a salt, and a neutralizing agent. The polyolefin-based polymer can be a low melting point polyolefin-based polymer. The polyolefin-based polymer can have a density greater than 0.80 (g/cm³). For example, the polyolefin-based polymer comprising the polyolefin can have a density in a range from 0.80 to 1.1 g/cm³, 0.89 to 1.0 g/cm³, 0.90 g/cm³, or 0.91 to 0.97 g/cm³.

The polyolefin-based polymer can comprise polypropylene and/or polyethylene, such as high density polyethylene, medium density polyethylene, low density polyethylene, or combinations thereof. As used herein, high density polyethylene refers to polyethylene having a density in a range from 0.93 to 0.97 grams per cubic centimeter (g/cm³). All individual values and subranges from 0.93 to 0.97 g/cm³ are included and disclosed herein. As used herein, medium density polyethylene refers to polyethylene having a density less than the high density polyethylene. As used herein, low density polyethylene refers to polyethylene having a density less than the medium density polyethylene.

The polyolefin-based polymer can comprise homopolymers and/or copolymers, including elastomers of a polyolefin, e.g. polymers of polyethylene and/or polypropylene. The polyolefin-based polymer can be chosen from the group comprising but not limited to ethylene, propylene, 1-butene, 3-methyl-1-butene, 4-methyl-1-pentene, 3-methyl-t-pentene, 1-heptene, 1-hexene, 1-octene, 1-decene, 1-dodecene, polyethylene, polypropylene, poly-1-butene, poly3-methyl-1-butene, poly3-methyl-1-pentene, poly-4-methyl-1-pentene, ethylene-propylene copolymer, ethylene-butadiene, ethylene-ethylidene norbornene copolymer ethylene-propylene-butadiene copolymer, ethylene-propylene-dicyclopentadiene copolymer, ethylene-propylene-1,5 hexadiene copolymer, ethylene-propylene-ethylidene norbornene copolymer; ethylene-vinyl acetate copolymer, ethylene-vinyl ethylene-vinyl alcohol copolymer, ethylene-vinyl chloride copolymer, ethylene acrylic acid or ethylene-(meth)acrylic acid copolymers, ethylene-(meth) acrylate copolymer, and ethylene butene (ENGAGE™ 7447) and ultra low density ethylene-octene (ENGAGE™ 8842).

The polyolefin-based polymer may include a functionalized polyolefin based on polypropylene or polyethylene homopolymer or copolymer where the polymer has been modified with a hydroxyl, an amine, an aldehyde, an epoxide, an ethoxylate, a carboxylic acid, an ester, an anhydride group, or combinations thereof. The polyolefin may include an unfunctionalized polyolefin such as commercially available high density polyethylenes including but not limited to, DMDA-8007 NT 7 (Melt Index 10, Density 0.943), DMDA-1210 NT 7 (Melt Index 10, Density 0.952), HDPE 17450N (Melt Index 17, Density 0.950), DMDA-8920 NT 7 (Melt Index 20 Density 0.954), DMDA 8940NT 7 (Melt Index 44, Density 0.951), DMDA-8950 NT 7 (Melt Index 50 Density 0.942), and DMDA-8965-NT 7 (Melt Index 66, Density 0.952) all available from the Dow Chemical Company. Other examples of suitable polyolefin-based polymers are propylene-ethylene alternating copolymers and propylene-ethylene diblock copolymers and propylene-ethylene alternating copolymers. These are all available from the Dow Chemical company.

The polyolefin may have different molecular weights for various applications. For example, the polyolefin may have a molecular weight of greater than 800 grams/mole; for example, greater than 5000 grams/mole; or greater than 50,000 grams/mole. The polyolefin may have a crystalline melting point of lower than 45° C., or lower than 50° C.

The polyolefin may be a propylene-alpha olefin copolymer, for example, propylene-ethylene or a propylene-ethylene-butene copolymer or interpolymer. The polyolefin may be a propylene/alpha-olefin copolymer, which is characterized as having substantially isotactic propylene sequences. “Substantially isotactic propylene sequences” means that the sequences have an isotactic triad (mm) measured by ¹³C NMR greater than 0.85; in the alternative greater than 0.90; in another alternative greater than 0.92 and in another alternative, greater than 0.93. Isotactic triads are well known in the art and are described in U.S. Pat. No. 5,504,172 and International Publication No. WO 00/01745.

The polyolefin-based polymer can include units derived from propylene and polymeric units derived from one or more alpha-olefin comonomers. Examples of comonomers that can be utilized to manufacture the base polymer are C₂, and C₄ to C₁₀ alpha-olefins; for example, C₂, C₄, C₆ and C₈ alpha-olefins. The base polymer can include from 1 to 40 percent by weight of units derived from one or more alpha-olefin comonomers. All individual values and subranges from 1 to 40 weight percent are included herein and disclosed herein. The polyolefin-based polymer can be characterized as including between 60 and 100, 80 and 99, or between 85 and 99 weight percent of units derived from polyethylene and between greater than zero and 40, 1-20, 4-16, or between 4 and 15 weight percent units derived from at least one other polyolefin.

The polyolefin-based polymer can be characterized as including between 60-100, 80-99, or between 85-99 weight percent of units derived from polypropylene and between greater than zero and 40, 1-20, or between 4-15 weight percent units derived from at least one other polyolefin.

The polar component can be a stabilizing agent. The polar component can be polar polyolefins. The polar component can be chosen from the group comprising but not limited to ethylene-acrylic acid and ethylene-methacrylic acid copolymers such as PRIMACOR™ 5980 and NUCREL™ 960. The polar component can also be chosen from the group comprising but not limited to ethylene ethyl acrylate copolymer, ethylene methyl methacrylate, ethylene butyl acrylate and combinations thereof. Other ethylene-carboxylic acid copolymers may also be used.

The polar component can include a functionalized polyolefin e.g., a polypropylene or polyethylene homopolymer or copolymer in which the polymer has been modified with a hydroxyl, an amine, an aldehyde, an epoxide, an ethoxylate, a carboxylic acid, an ester, an anhydride group, or combinations thereof.

The polyolefin dispersion can comprise a neutralizing agent such that the polyolefin-based laminating adhesive has a pH from 8 to 11. All individual values and subranges from 8 to 11 are included herein and disclosed herein. For example, the polyolefin dispersion can have a pH from a lower limit of 8, 8.1, 8.2, or 8.3 to an upper limit of 11, 10.9, 10.8, or 10.7. For example, the aqueous dispersion can have a pH from 8 to 11, 8.1 to 10.9, 8.2 to 10.8, or 8.3 to 10.7.

The neutralizing agent can have a boiling point of less than 140° C. Examples of suitable neutralizing agents include but are not limited to, hydroxides, carbonates, hydrogen carbonates, amines, and combinations thereof. Examples of suitable hydroxides include, but are not limited to, ammonium hydroxide, potassium hydroxide, lithium hydroxide, sodium hydroxide, and combinations thereof. Examples of suitable carbonates include, but are not limited to, sodium carbonate, sodium bicarbonate, potassium carbonate, calcium carbonate, and combinations thereof. Examples of suitable amines include, but are not limited to, monoethanolamine, diethanolamine, triethanolamine, ammonia, monomethylamine, dimethylamine, trimethylamine, 2-amino-2-methyl-1-propanol, triisopropanolamine, diisopropanolamine, N,N-dimethylethanolamine, mono-n-propylamine, dimethyl-n propylamine, N-methanol amine, N-aminoethylethanolamine, as well as amines such as morpholine, piperazine, piperidine, and combinations thereof.

The polyolefin dispersion can have a concentration of active product less than 55% by weight. The polyolefin dispersion can have a water content greater than 45% by weight, based on the total weight of the polyolefin dispersion.

### Laminate Formation:

A recyclable laminate structure with improved recyclability properties can be produced by coating a recyclable polyolefin substrate layer with a polyolefin based dispersion composition comprising a polyolefin-based polymer, a polar component present as a salt, and a neutralizing agent. The recyclable laminate structure produced should have a recyclability property of less than a 50 percent change in performance compared to a substrate layer without the polyolefin based dispersion composition. The “recyclability” property of the laminate structure of the present invention can be measured by the laminate's properties including, for example, the laminate's: (1) mechanical properties (e.g., tensile modulus), and (2) IR absorbance properties by comparing the same properties to that of a laminate structure of the prior art. Other properties, such as clarity and gel content, of the films present in the multi-layer laminate structure of the recycled materials can be measure, if desired, to further determine the recyclability of the laminate film structure.

A mono-material with improved recyclability properties can be produced by applying a polyolefin dispersion composition comprising a polyolefin-based polymer, a polar component present as a salt, and a neutralizing agent to a first recyclable polyolefin substrate layer. A second recyclable polyolefin substrate layer is then laminated to the first recyclable polyolefin substrate layer. The mono-material produced should have a recyclability property of less than a 50 percent change in performance compared to a mechanically recyclable mono-material without the coating layer. The known application system by which the polyolefin dispersion is applied can be a gravure process. The known application process by which the polyolefin dispersion is applied can be a flexographic, a semi flexographic, or a rotogravure process. The polyolefin dispersion can be applied with a laminator using a rotogravure cylinder. The coating weight can be kept between 2 to 4 g/m² dry during application of the polyolefin dispersion. The polyolefin dispersion is completely dried in the drying tunnel. The first substrate layer, where the polyolefin dispersion has been applied and dried, can be nipped to a secondary substrate layer in a calander. During lamination the noncoated side of the first substrate layer can contact a metallic cylinder. During lamination the second substrate layer can contact a rubber roller. During lamination the metal cylinder can be heated to a temperature of 90° C. or higher. During lamination the adhesive can reach a temperature of 40° C. During lamination the adhesive can reach a temperature of 50° C. During lamination the adhesive can reach a temperature slightly higher than the adhesive's first melting point peak. During lamination the lamination machine can run at a speed of 10 m/min. The lamination machine can be run at 50 m/min during lamination. After lamination the multi-layer laminate can be stored at 60° C. for 24 hours.

While not being bound by theory, it is believed that ionic content, and hardness of base used can lead to failure of the current disclosure. This is thought to lead to a polar adhesive that can fail to hold the two nonpolar substrate layers together. Drying is thought to counter this so if a base with a high ionic content is used, a high lamination speed is used, or the metal cylinder is heated to a lower temperature during lamination post lamination heating may be needed to reach desired bond strength.

Laminates made using the current disclosure can have a bond strength between 1.7 and 3N/15 mm. Laminates made using the current disclosure can have a bond strength between 2 and 3N/15 mm. Laminates made using the current disclosure can have a bond strength between 2 and 2.5N/15 mm.

The recyclable laminate structures of the present disclosure can be used, for example, in packaging applications for manufacturing various packaging materials and products. For example, the recyclable laminate structures can be used for bulk packaging of food grains/pulses, packaging of seeds, packaging of lentils and cereals, packaging of fertilizer, packaging of oilseed, packaging of sugar, packaging of salt, packaging of pharmaceuticals, packaging of other food stuff, and personal care items such as bath salts, detergent pods and the like. The recyclable laminate structures may also be used as a wrapper for baby wipes, feminine hygiene products, cereal bars, protein bars, cheese and confectionary products. Also, other advantageous features and applications for the recyclable substrate layer when used for packaging articles include, for example, resistance to severe weathering conditions, high tensile strength, robust drop test resistance, excellent optical appearance, and resistance to spills.

### EXAMPLES

TABLE 1
Raw Materials Used in the Examples:

| | | | | Acid Value (mg |
|---|---|---|---|---|
| Material | Description | MI (ASTM 1238) | Tm (° C.) | KOH/g) |
| ENGAGE ™ 7447 | Ethylene butene copolymer | 5 | 35 | 0 |
| ENGAGE ™ 8842 | Ethylene octene copolymer | 1 | 38 | 0 |
| PRIMACOR 5980i | Ethylene acrylic acid | 300 | 77 | 154 |
| | copolymer | | | |
| NUCREL 960 | Ethylene methacrylic acid | 60 | 91 | 98 |
| | copolymer | | | |
| RETAIN 3000 | MAH-g ethylene octene | 500 | 67.8 | 5-7 |
| | copolymer | | | |
| OLEIC ACID | Octadec-9-enoic acid | n/a | 15 | 194 |
| EMAA POLYMER | Ethylene methacrylic acid | 250 | 84 | 122 |
| | copolymer | | | |
| SURLYN PC 2000 | Ethylene methacrylic acid | 4.5 | 84 | 122 |
| | Na ionomer | | | |

TABLE 2

| | Component 1 | Component 2 | Component 3 | Initial | Neutralizing | Dilution |
|---|---|---|---|---|---|---|
| | feed rate | feed rate | feed rate | water rate | Base | water rate |
| Example | (g/min) | (g/min) | (g/min) | (ml/min) | (ml/min) | (ml/min) |
| IE1 | ENGAGE ™ 7447 | PRIMACOR ™ 5980i | n/a | 39 | DMEA | 112 |
| | (78.1) | (33.5) | | | (13.5) | |
| IE2 | ENGAGE ™ 7447 | PRIMACOR ™ 5980i | n/a | 21.8 | NH₄OH | 79 |
| | (52.9) | (22.7) | | | (5.3) | |
| IE3 | ENGAGE ™ 7447 | NUCREL ™ 960 | n/a | 18.15 | KOH | 85 |
| | (53) | (22.7) | | | (4.04) | |
| IE4 | ENGAGE ™ 7447 | RETAIN ™ 3000 | Oleic acid | 4.43 | DMEA | 110 |
| | (65.5) | (7.57) | (2.648) | | (1.04) | |
| IE5 | ENGAGE ™ 7447 | PRIMACOR ™ 5980 | n/a | 20.97 | DMEA | 110 |
| | (53) | (22.7) | | | (9.4) | |
| IE6 | ENGAGE ™ 7447 | PRIMACOR ™ 5980 | n/a | 26.40 | DMEA | 110 |
| | (53) | (22.7) | | | (9.4) | |
| IE7 | ENGAGE ™ 7447 | EMAA polymer | SURLYN ™ | 20.61 | DMEA | 100 |
| | (52.97) | (15.44) | PC 2000 | | (7.9) | |
| | | | (7.26) | | | |
| IE8 | ENGAGE ™ 8842 | PRIMACOR ™ 5980 | n/a | 18.38 | DMEA | 75 |
| | (53) | (22.7) | | | (10.0) | |

| | Extruder Temp | Extruder | | Vmean | Viscosity |
|---|---|---|---|---|---|
| | in Polymer | Speed | Solids | Particle Size | (cP) |
| Example | Melt zone (° C.) | (rpm) | (wt. %) | (micron) | SP#, rpm |
| IE1 | 90 | 450 | 38.84% | 0.59 | 332 |
| | | | | | SP3, 50 |
| IE2 | 90 | 450 | 41.17% | 1.27 | n/m |
| IE3 | 140 | 450 | 43.0% | 0.82 | 444 |
| | | | | | SP2, 20 |
| IE4 | 140 | 450 | 42.93% | 0.78 | 64 |
| | | | | | SP1, 50 |
| IE5 | 140 | 450 | 38.32% | 1.61 | 130 |
| | | | | | SP2, 50 |
| IE6 | 140 | 450 | 38.45% | 1.321 | 119 |
| | | | | | SP2 100 |
| IE7 | 140 | 450 | 35.28% | 0.926 | 61.9 |
| | | | | | SP1, 100 |
| IE8 | 140 | 450 | 45.47% | 2.217 | 1542 |
| | | | | | SP3, 50 |

### Dispersion Preparation: Examples 1 to 8

Aqueous dispersions 1 to 8 having compositions as disclosed in Table 2, above, are formed from raw materials disclosed in Table 1, above, using the conditions as described in Table 2, above, are prepared using the following general procedure:

Components 1 and 2 listed in Table 2, above, are fed into a 25 mm diameter twin screw extruder using a controlled rate feeder; using the feed rate in grams/minute (g/min) as indicated in Table 2, above. Components 1 and 2 are forwarded through the extruder and melted to form a liquid melt material. When present, component 3 is either pumped into this melt as a liquid (oleic acid) or also added into the extruder using a controlled rate feeder (SURLYN PC 2000).

The extruder temperature profile is ramped up to the temperature listed in the “Polymer Melt Zone” column of Table 2, above. Water and neutralizing base agent, which is either 30% wt. aqueous potassium hydroxide (abbreviated KOH), dimethylethanolaimne (abbreviated DEMA) or 29% wt. aqueous ammonia (abbreviated NH₄OH) is mixed together and fed to the extruder at the rates indicated in Table 2 at an initial water introduction site. Then dilution water is fed into the extruder at the rates indicated in Table 2. The extruder speed used in rpm is also recorded in Table 2. At the extruder outlet, a backpressure regulator is used to adjust the pressure inside the extruder barrel to a pressure adapted to reduce steam formation (generally, the pressure was from 2 MPa to 4 MPa).

Each aqueous dispersion exits from the extruder and is filtered first through a 200 micrometer (μm) filter. The resultant filtered aqueous dispersions has a solids content measured in weight percent (wt %); and the solids particles of the dispersion has a volume mean particle size measured in microns. The solids content of the aqueous dispersion is measured using an infrared solids analyzer; and the particle size of the solids particles of the aqueous dispersion is measured using a COULTER™ MLS-230 particle size analyzer (Beckman Coulter Corporation, Fullerton, CA). The solids content and the average particle size (PS) of the solids particles of the dispersion are indicated in Table 2, above.

Each polyolefin dispersion is applied to the respective substrate via rotogravure lamination using a LABO COMBI™ 400 laminator, commercially available from Nordeccanica Group. First the polyolefin dispersion is applied onto a first substrate layer (MDO-PE for all the samples listed in Table 3), the water is completely evaporated in the drying tunnel, and the first substrate layer is nipped to a secondary substrate layer (PE 1-09 for the laminated samples considered in this invention). The coating weight during this process is kept between 2 to 4 g/m² dry. During the nipping process, a metallic cylinder heated to 90° C. is in contact with the non-coated side of the primary substrate layer and a rubber roller is in contact with the noncoated second substrate. The produced laminate structure is then rewound.

Table 3 summarize the Polyolefin substrates of used to produce the laminates containing dispersion from inventive and comparative examples.

TABLE 3
Polyolefin substrates

| Product name | Description | Vendor name |
|---|---|---|
| MDO PE | 5 layers blocked MDO PE | Produced at |
| | | Windmöller & |
| | | Hölscher with |
| | | Dow formulation |
| P109000FN00 | Transparent monoextruded PE (EVA) | Ticinoplast |
| PE film for | Coextruded three-layer PE | Dow |
| recyclability | blown-film (high density LLDPE) | |
| test | | |

The bond strength of the laminates produced starting from the Illustrative Examples (IE) and the Comparative Examples (CE) are tested on an Instron tensile tester with a 50 N loading cell. Fifteen millimeter strips are tested a rate of 100 mm/min. Three strips are tested for each laminate and high and mean strength are recorded together with the failure mode. In cases of substrate layer tear and stretch, the high value is reported and in other failure modes the average T-peel bond strength is reported. The bond strength is tracked immediately after application (green tack), after 1 day, and after 7 days. The lamination speed for all examples is 10 m/min. Results for laminated structures from both inventive and comparative examples are shown in table 43.

Comparative Example 1 in Table 43 is HYPOD™ 1000 an aqueous acid-modified polyolefin dispersion available from DOW™. Comparative Example 2 is ADCOTE™ 37 JD 1198 BW, a water based dispersion comprised of high molecular weight ethylene interpolymers.

TABLE 4
Bond Strength tested on laminates produced
with Illustrative and Comparative Examples

| | Dry | | | | | | |
|---|---|---|---|---|---|---|---|
| | Coating | Green | | 1-day | | 7-day | |
| | Weight | Tack Bond | | Bond | | Bond | |
| Sample | applied | Strength | | Strength | | Strength | |
| Description | (g/m²) | (N/15 mm) | | (N/15 mm) | | (N/15 mm) | |
| Laminate from CE1 | 4 | 1.6 | COI | 1.4 | COI | 0.45 | a MDO |
| Laminate from CE2 | 4 | 1.5 | COI | 1.3 | A PE | 1.2 | a PE |
| Laminate from IE1 | 4 | 1.8 | COI | 2.3 | COI | 2.2 | a PE |
| Laminate from IE2 | 4 | 2.4 | a MDO | 2.4 | a MDO | 2 | a MDO |
| Laminate fromIE3 | 4 | 1.1 | a MDO | 0.1 | a MDO | 0.12 | a MDO |
| Laminate from IE4 | 4 | 0.9 | a PE | 0.8 | a PE | 0.89 | a PE |
| Laminate fromIE5 | 4 | 1.9 | COI | 1.7 | COI | 2.3 | COI |
| Laminate from IE6 | 5.6 | 2.1 | a MDO | 1.65 | a MDO | 2.5 | a MDO |
| Laminate from IE7 | 3.7 | 1.8 | a MDO | 1.9 | a PE | 1.3 | a MDO |
| Laminate from IE8 | 3.3 | 2.1 | a MDO | | | 2.5 | COI |

COI = Cohesion failure
a MDO = AF adhesive failure with adhesive remaining on MDO PE film surface
a PE = AF adhesive failure with adhesive remaining on non-oriented PE layer (sealing film)

TABLE 5
Bond Strength tested on laminates produced with Inventive
Example6 under Differing lamination Conditions

| | | Temperature | | |
|---|---|---|---|---|
| | | reached by the | | Bond |
| | Lamination | adhesive layer | | Strength |
| Sample Description | speed | during calandering | Testing condition | (N/15 mm) |
| Laminate from IE6 | 10 m/min | >50° C. lamination | tested after 7dd | 2.5 |
| | | (54° C. reached at | from lamination | |
| | | 10 m/min lamination | | |
| | | speed) | | |
| Laminate from IE6 | 50 m/min | <40° C. Lamination | tested after 7dd | <0.1 |
| | | (38° C. reached at | from lamination | |
| | | 50 m/min lamination | | |
| | | speed) | | |
| Laminate from IE6 | 50 m/min | <40° C. Lamination | tested at room | 2.3 |
| | | (38° C. reached at | temperature after | |
| | | 50 m/min lamination | storing post | |
| | | speed) | lamination for | |
| | | | 24 h at 60° C. | |

As shown in Table 5, at an application temperature during lamination of 54° C. at the calendering step adhesion values around 2N/15 mm are reached, while if a temperature of only 38° C. is reached almost no adhesion develops between the MDO PE and PE layer. However, if laminate produced at 38° C. at the calendering step is stored at 60° C. for twenty-four hours a bond strength comparable to the sample with an application temperature of 54° C. can be achieved.

To reach a bond strength of 2N/15 mm or greater the temperature when the dried polyolefin layer applied on the first substrate layer is calendared against the secondary substrate layer must be slightly higher than the adhesives first melting point.

### Recyclability Evaluation:

Two PE films (PE film for recyclability test) are produced and laminated with the disclosed PE based adhesive as described above (IE6). Laminated material is grinded into flakes of 10 to 20 mm and dried in ambient air for 24 h. Non-laminated PE film is similarly grinded. Both sets of grinded sample were then extruded at a temperature of 250° C. A blend consisting of 50% non-laminated PE film and 50% virgin LDPE (B0) along with a blend consisting of 50% virgin LDPE and 50% PE material laminated with the disclosed adhesive is produced (B100). Both blends are used to create blown film at a melt temperature between 200-230° C., a thickness<25 μm, and a blow-up ratio>2.5. Results of the recyclability evaluation are shown below in Table 4.

TABLE 4
Recyclability

| | Elmendorf | Elmendorf | Elongation at | Tensile Strength |
|---|---|---|---|---|
| Blend | tear MD (g) | tear CD (g) | Yield MD % | MD [MPa] |
| B 100 | 148.00 | 319.00 | 3.38 | 24.36 |
| B0 | 159.50 | 262.25 | 3.65 | 26.22 |

| | Elongation at | Tensile Strength | Gel | Haze | Clarity |
|---|---|---|---|---|---|
| Blend | Yield CD [%] | CD [MPa] | Content | [%] | [%] |
| B100 | 6.61 | 20.21 | 1.60 | 15.80 | 86.50 |
| B0 | 6.37 | 21.08 | 0.73 | 19.80 | 83.58 |

1. A recyclable laminate structure with improved recyclability properties, comprising:
a. a first substrate layer comprising a recyclable polyolefin;
b. a recyclable polyolefin based dispersion composition applicable via a known application system comprising: a polyolefin-based polymer, a polar component present as a salt, and a neutralizing agent.

2. The recyclable laminate structure of claim 1 comprising:
a. the first substrate layer comprising the recyclable polyolefin;
b. the recyclable polyolefin based dispersion composition applied to the first substrate layer; wherein the first substrate layer is laminated to a second substrate layer comprising a recyclable polyolefin, and forming a mechanically recyclable multi-layer laminate.

3. The recyclable laminate structure of claim 1 wherein the known application system is a gravure process.

4. A recycled article made either from the recyclable laminate structure of claim 1.

5. A packaging article made from the recyclable laminate structure of claim 1.

6. The recyclable laminate structure of claim 1 wherein the substrate layer is dried post lamination prior to use.

7. A process for producing a recyclable laminate structure with improved recyclability properties, comprising:
a. providing a first substrate layer comprising a recyclable polyolefin; and
b. applying a polyolefin based dispersion composition comprising a polyolefin-based polymer, a polar component present as a salt, and a neutralizing agent to the first substrate layer via a known application system to form the recyclable laminate structure with improved recyclability properties.

8. The process of claim 7, comprising:
a. providing the first substrate layer;
b. providing a second substrate layer comprising a recyclable polyolefin; and
c. applying the polyolefin dispersion to the first substrate layer; wherein the first substrate layer is laminated to the second substrate layer to form a mono-material with improved recyclability properties.
